(19) United States
(12) Patent Application Publication
(10) Pub. No.: US 2014/0012736 A1
(43) Pub. Date: Jan. 9, 2014

(54) CREDIT SERVICES ORGANIZATION TRANSACTIONS

(71) Applicant: Cerf Stanford Ross, II, Austin, TX (US)

(72) Inventor: Cerf Stanford Ross, II, Austin, TX (US)

(21) Appl. No.: 13/935,350

(22) Filed: Jul. 3, 2013

Related U.S. Application Data
(60) Provisional application No. 61/667,889, filed on Jul. 3, 2012.

(51) Int. Cl. G06Q 40/02

(52) U.S. Cl. CPC G06Q 40/025
USPC 705/38

(57) ABSTRACT

A system and associated methodology are described for staging universal CSO transactions to facilitate loans from lenders to consumers by receiving at a CSO a promise-to-pay record, credit extension agreement and separate personal property asset from a consumer in support of issuing a guaranty of repayment to a lender, and then processing payments from the consumer to obtain payment of principal, interest, and a CSO transaction fee either from consumer payments or from the separate personal property asset upon payment default.

The present patent application claims priority to U.S. Provisional Patent Application No. 61/667,889, filed Jul. 3, 2012, which is hereby incorporated by reference in its entirety.

### FIELD

Disclosed subject matter is directed in general to financial transaction systems and methods and, more particularly, to systems and methods supporting credit services organization transactions that facilitate loans between lenders and consumers.

### DESCRIPTION OF THE RELATED ART

A wide variety of consumer credit services are available for consumers who are interested in obtaining consumer credit loans from lenders. A credit service organization (CSO) may provide certain services with respect to the extension of consumer credit by others in exchange for payment of valuable consideration by the consumer and/or the lender. Examples of such consumer credit extension services include providing services relating to improving a consumer's credit history or rating, obtaining an extension of consumer credit for a consumer, or providing advice or assistance to a consumer with regard to the previous two services.

### BRIEF SUMMARY

Disclosed subject matter relates generally to universal credit services organization transaction systems and methodologies, and in particular to systems and methods for performing transactions that facilitate loans by a lender or merchant to consumers to consummate a financial transaction and/or to maintain a financial relationship. In some embodiments, money is loaned directly from the lender to the consumer and a CSO transaction system, acting as a limited special agent (LSA), arranges, collects, and otherwise services a loan for the lender without actually lending any money to the consumer. Disclosed CSO transaction systems and methods may facilitate payments by consumers in support of such transactions by arranging and approving a loan between the lender and the consumer using predetermined underwriting criteria. The CSO transaction system may facilitate the loan by processing and approving a loan application from a consumer. The CSO transaction system may receive promise-to-pay data record, also referred to herein as promise-to-pay data, indicative of a promissory note or other instruction evidencing a consumer promise to repay a loan from a lender with interest according to specified terms. The CSO transaction system may provide a CSO disclosure and a credit extension agreement to the consumer. The credit extension agreement may indicate a consumer promise to pay a CSO transaction fee to the CSO according to specified terms, e.g., a lump sum at loan maturity. In addition, the CSO may receive a value asset, e.g., personal property or an acceptable physical object, and the CSO transaction system may maintain value asset data identifying the value asset. In some embodiments, the monetary value of the value asset is greater than or equal to the CSO transaction fee and the value asset may be redeemed or converted by the CSO. The CSO transaction fee may encompass fees to cover the CSO's underlying overhead cost of doing business, which may include the cost for the CSO to provide repayment guaranty and/or letter of credit to the lender for the principal and interest amounts. As an LSA for the lender, the CSO may collect principal and interest payments from the consumer and the CSO transaction system may associate payment data with the promise-to-pay data to determine compliance with the terms of the promise-to-pay. The CSO transaction system may send notices to the lender when payments have been received. In the event that payments required by the promise-to-pay and the credit extension agreement are made, the value asset is returned to the consumer, the principal and interest payments are made to the lender, and the CSO retains the CSO transaction fee. However, if payments required by the promise-to-pay record and the credit extension agreement are not made, the value asset may be converted by the CSO to pay for at least the CSO transaction fee, and the CSO may then make principal and interest payments to the lender and retain the CSO transaction fee. To this end, the CSO transaction system may store promise to pay data, credit extension agreement data, value asset data, and payment data in a database or memory to represent the applicable elements of the loan transaction, including the credit extension agreement. The CSO transaction system may process payment data to verify compliance with the promise to pay as indicated in the promise to pay data.

### BRIEF DESCRIPTION OF THE DRAWINGS

Claimed subject matter may be understood, and its numerous objects, features and advantages obtained, when the following detailed description is considered in conjunction with the following drawings, in which:

FIG. 1 depicts selected elements or an embodiment of a credit services organization transaction system; and

FIG. 2 depicts selected elements of an embodiment of a method for operating a credit services organization.

### DETAILED DESCRIPTION

A system and associated methodology are described for staging universal credit services organization transactions that facilitate loans by a lender or merchant directly to consumers to consummate a financial transaction and/or to maintain a financial relationship. In one embodiment, a loan from a lender to a consumer is facilitated with a loan arrangement according to which the CSO acts as an LSA for the lender to approve a loan to a consumer using underwriting criteria furnished by the lender. The CSO, acting as limited special agent arranges, perhaps through a third party vendor, to handle customer paperwork incidental to the lender's loan and assimilate customer information used in approving the customer's loan request. As the LSA, the CSO does not execute the customer's promissory note, but the consumer promises to repay the loan amount to the lender through the CSO, who is acting on behalf of the lender as LSA to collect monies for the lender. The LSA function(s) may be performed in whole or in part by the CSO, where one or more loan processing functions may be distributed or outsourced to one or more third party processing entities. The CSO may enter into a separate agreement with the consumer in which the consumer agrees to pay a transaction fee to the CSO (CSO transaction fee) for obtaining an extension of consumer credit for the consumer, pursuant to which the CSO may receive and hold a value asset such as personal property owned by the consumer from the consumer. The value asset may be valued in an amount equal to at least the CSO transaction fee to the CSO due at the loan's maturity, alone or in combination with the CSO's underlying overhead cost of doing business and/or the amount of principal and/or interest the consumer will owe to the lender. These overhead costs may include the consumer's share of the costs for the CSO's guaranty to the lender for the amount of all loans made by the lender to the consumers approved by the CSO, as well as transaction fees paid by the CSO to the lender in connection with the CSO-brokered loans. The received value asset may be used by the CSO as security for the CSO transaction fee. Once the value asset is received, the CSO may enter into an agreement with the consumer in which consumer and CSO agree that if the consumer pays the principal and interest of the loan by the due date, the consumer may reclaim the personal property by paying the CSO transaction fee. The agreement may further provide that, if the CSO transaction fee is not paid, the value asset may be converted by the CSO to pay for at least the CSO transaction fee. In selected embodiments, the CSO may issue a guaranty to the lender for the aggregate amount of all CSO-brokered loans by lender, and provide a letter of credit to the lender to secure the CSO's guaranty of payment of the principal and interest of the loans.

Various illustrative embodiments will now be described in detail with reference to the accompanying figures which illustrate the inventive functionality with simplified schematic and flow diagram representations of selected system components and processing steps. While various details are set forth in the following description, it will be appreciated that claimed subject matter encompasses embodiments that may or may not include these specific details, and that numerous implementation-specific modifications or alternatives to the embodiments described herein may be made to achieve various objectives including, as examples, compliance with process technology or design-related constraints, which may vary from one implementation to another. For example, selected aspects are shown in block diagram form, rather than in detail, for the sake of clarity. Some portions of the detailed descriptions provided herein are presented in terms of algorithms or operations on data within a computer memory. Such descriptions and representations are used by those skilled in the data processing arts to describe and convey the substance of their work to others skilled in the art. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In connection with the purchase of various goods and services, financing assistance may be used by the consumer, customer, borrower, or the like to structure purchase price payments to the lender that provides the goods and/or services. With expensive items such as a home, automobile, or another expensive piece of real or personal property, the consumer may wish to borrow money from the lender or some other third party lender. The borrowed monies typically are paid back to the lender, or a designated third party, over a period of time, typically within a designated term. As compensation for lending money, the lender charges the consumer interest on the unpaid loan principal at a specified interest rate. The borrower repays the loan, plus interest, in a series of payments (e.g., monthly, quarterly, or the like). Loan repayments by the consumer are typically made by mailing monthly checks to the lender, or otherwise arranging for electronic funds transfer (EFT) to automatically make the monthly payments from the consumer's credit account, checking account, brokerage account, or other designated consumer account, though other repayment arrangements can be made. With EFT payments, a consumer preauthorizes electronic debits of a desired loan payment amount so that the authorized lender can originate a computer file containing payment information and transmit the debit through an automatic clearing house (ACH) network to the financial institution maintaining the consumer's designated account. The proper amount is debited from the customer's designated account, and forwarded to the lender or credited to a lender account. With both direct and EFT payments, the lender maintains a record of the loan payments for purposes of tracking the payment record of the consumer, including, whether the consumer has missed any payments and, if so, how many.

While conventional loan repayment schemes can work well when the consumer has sufficient credit worthiness and resources to maintain the loan repayment schedule, problems can arise if a consumer's designated account does not have sufficient funds or for any other reason that prevents the consumer from repaying the loan on the requested repayment schedule. In addition, there are certain overhead costs associated with finding consumers who wish to enter into loan arrangements, particularly for lenders engaged in the business of lending money. There are also risks and costs for the lender associated with processing payment delinquencies or default, particularly if the lender seeks to satisfy the outstanding debt by recovering the property or merchandise that was the subject of the loan. For example, a lender may be required to initiate foreclosure proceedings on a mortgaged property in an attempt to recoup the balance of the unpaid loan or if the consumer has missed several payments in a row, or several payments over a designated period of time. There can also be risks associated with taking deferred presentment items (e.g., post-dated checks or ACH authorizations) to secure repayment of the loan inasmuch as the financial condition of the consumer may change over time so that the deferred presentment item loses value.

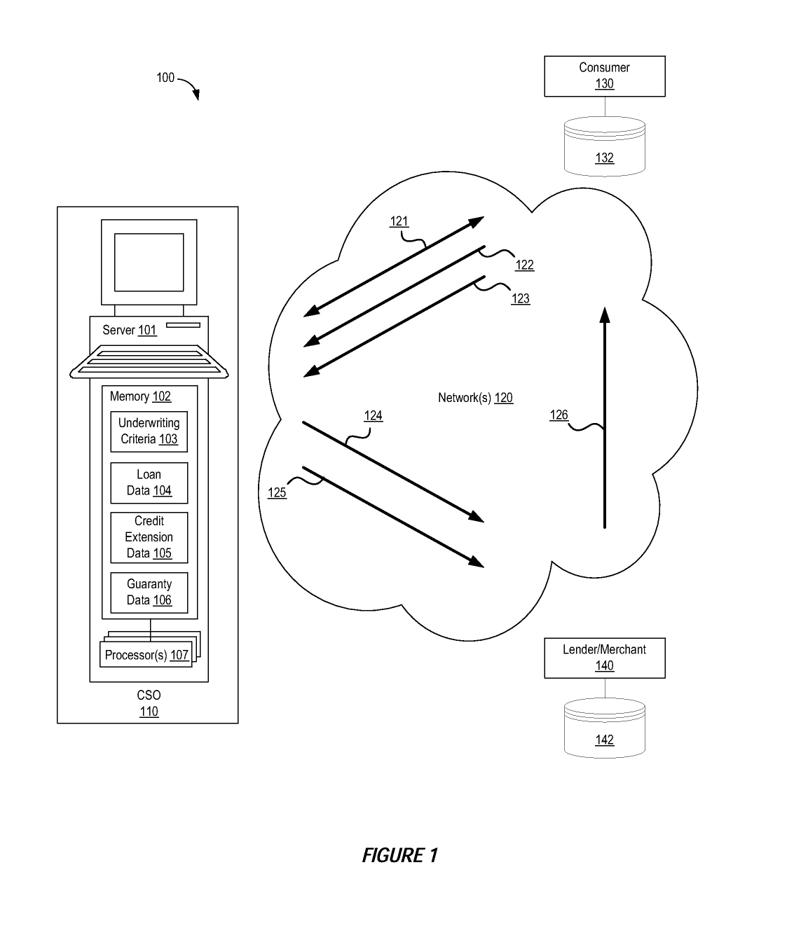

In this context, selected embodiments provide a financing transaction system and methodology whereby a CSO facilitates loans by a lender or merchant to a consumer by, for example, approving and processing loan applications from a consumer and arranging for repayment without the CSO directly lending or advancing money to the consumer. The loan facilitation activities by the CSO do not include lending money from the CSO to the consumer. Instead, the CSO acts as a limited special agent for the lender to broker, collect, and service the lender's loans to its consumers. With reference to FIG. 1, there is provided a depiction of selected elements of an embodiment of a universal credit services organization transaction 100 wherein a CSO 110 facilitates a loan arrangement between a consumer 130 and a lender 140 to consummate a financial transaction and/or to maintain a financial relationship for any of a number of reasons, including for the purchase of goods or services, loan repayment, and the like. As depicted, CSO 110 arranges a loan 126 from lender 140 to consumer 130, and consumer 130 agrees to pay the loan amount including principal and interest by sending loan repayment transactions 121 to CSO 110 as an LSA for lender 140, consumer 130 executes a credit extension agreement represented by credit extension agreement information 122, in which consumer 130 agrees to pay a CSO transaction fee to CSO 110 for arranging the loan and pledges a value asset, represented by value asset information 123, to secure payment of the CSO transaction fee. Value asset information 123, which may include information identifying the value asset, a value for the asset, and the consumer's pledge of the value asset to the CSO, may be stored as value asset data (not expressly depicted) in server memory 102. In at least one embodiment, CSO 110 provides lender 140 with loan repayment information indicating any payments CSO 110 receives from consumer 130 and indicating, when applicable, the consumer's compliance or non-compliance with the loan terms as represented by loan data 104.

As shown in FIG. 1, consumer 130, lender 140, and/or CSO 110 may use a computer or other suitable control system to effectuate transactions 121-126 (described below) as being transmitted over a network 120, though this is not necessarily required. For example, lender 140 may include a computer, control system, or other hardware which includes or is coupled to a memory storage device 142 e.g., a database that is used to maintain accounts and other information related to customer loans. Likewise, consumer 130 may include a computer or control system that includes or is coupled to a memory storage device 132 e.g., a database that is used to maintain accounts and other information related to the loan repayment actions of the consumer/customer. As will be appreciated, the computer or control systems at lender 140 and/or consumer 130 may be implemented with any desired computer system, software and related user interface that allows a user to view, present, query, process, transform, revise, calculate and update data and loan account or payment information. In other embodiments, computer or control systems associated with consumer 130 and lender 140 can be any computer or related device capable of communicating with other types of communication devices or computers, such as a mainframe computer, server computer, personal computer, a personal digital assistant (PDA), laptop computer, other wired or wireless devices, hand-held devices, and the like. Likewise, storage devices 132, 142 may be any of a wide variety of storage devices (e.g., magnetic storage systems such as tape or disk, optical storage systems, such as CD or DVD systems, and solid state systems such as RAM or ROM, and the like) that are suitable for storing a record of customer loans, purchases, payments, and the like.

To facilitate the universal credit services organization transactions described herein, CSO 110 may include a server 101 or other form of computer or data processing system that communicates with lender 140 and/or consumer 130 over a network 120 e.g., a private wide area network (WAN) or the Internet. As depicted in FIG. 1, lender 140 represents, in addition to the lender entity, a computer or other data processing system suitable for communicating with other computers, including server 101, over network 120. Similarly, the consumer 130 depicted in FIG. 1 includes, in addition to the individual consumer, a computer or other data processing system, including desktops, laptops, smart phones, and tablets. Server 101 includes a general or special purpose microprocessor, a storage medium, accessible to the processor, including processor-executable program instructions and processor-accessible data structures, and an network interface enabling server 101 to communicate via network 120 with other data processing systems.

In at least one embodiment, communication between the CSO server 101 and the networked computer systems associated with consumer 130 and lender 140 is supported by one or more a service provider, such as an Internet service provider (not explicitly shown), by executing application specific software, commonly referred to as a browser, on each computer system. The example CSO server 101 may include one or more processors 107 and associated memory 102 used to store and process software instructions and data for staging a financial transaction by using underwriting criteria 103 to approve and store a loan application. When a loan application is approved by CSO 110 acting as an LSA for lender 140, consumer 130 may sign a loan repayment agreement wherein consumer 130 agrees to repay the loan amount, including principal and interest, to the lender through the CSO 110 as an LSA for the lender 140. In this role, the CSO 110 does not lend money to consumer 130. In FIG. 1, information pertaining to the loan application, loan approval, loan terms, and repayment agreement are stored in server memory 102 as loan data 104, which may include promise-to-pay data containing consumer-related loan repayment information, such as the amount and possible methods of payment (e.g., cash only), the time the payment is due, additional fees, taxes, discounts, and the like. Promise-to-pay data in load data 104 may also include information indicating whether a late payment would be accepted and additional data indicating whether amounts other than the requested amount would be accepted, whether multiple payments are accepted towards the requested amount, and the like. The promise-to-pay data can be manually created, such as by a representative of lender 140. Alternatively, the promise-to-pay data may be automatically created by mapping the appropriate consumer data to a promise-to-pay record form created for or associated with consumer 130.

In support of the loan approval or brokerage service provided by CSO 110, consumer 130 may enter into a separate credit extension agreement and provide credit extension agreement information 122 to CSO 110. Credit extension agreement information may include information indicative of a promise by consumer 130 to pay a CSO transaction fee to CSO 110 for providing the loan arrangement services, assisting in preparing and completing the information and documents the lender of the loan requires the customer to submit in order to obtain the loan, and issuing the CSO's third party guaranty to assist customer 130 in obtaining loan 126 from lender 140. Credit extension agreement information 122, including the amount of the CSO transaction fee, may be stored in server memory 102 of CSO server 101 as credit extension data 105. Consumer 130 may convey or pledge to CSO 110 a value asset, represented value asset information 123, such as any valuable personal property or other physical object or service associated with the loan obligation having a value that is equal to or corresponds to at least the CSO transaction fee. In selected embodiments, the value asset has a value that is equal to or corresponds to at least the CSO transaction fee, alone or in combination with the CSO's overhead cost of doing business and/or the amount of principal and/or interest. Regardless of the valuation of the value asset, credit extension data 105 may also include data representing the value asset. By receiving a separate physical value asset as security for repayment of at least the transaction fee (if not also the amount of principal and interest and/or overhead business costs), there is less uncertainty about the credit worthiness of consumer 130 as might otherwise be the case if consumer 130 instead provided a post-dated check or ACH authorization.

The depicted embodiment of CSO server 101 may store and process data associated with loan repayment transactions 121 received from consumer 130 to process the loan repayments and to provide loan repayment information 124 to lender 140, thereby supporting the original loan extension from lender 140 to consumer 130 (as indicated with the transaction arrow 126). CSO 110 may provide guaranty information 125 to lender 140. Guaranty information 125 may include a CSO's guaranty that the loan principal and interest will be paid. In some embodiments, the CSO's guaranty is not directly tied to any particular loan to an individual consumer, but instead applies to the entire line of credit for all loans brokered by the CSO, whether universal or not. In some embodiments, CSO 110 may provide a letter of credit to lender 140 as part of guaranty information 125, to secure the CSO's guaranty of payment of the loan principal and interest amounts. Guaranty information 125 may be stored by CSO 110 as guaranty data 106. With this arrangement, guaranty information 125, representing the guaranty and letter of credit, may be part of a business arrangement between CSO 110 and lender 140 that applies to all loans, and therefore represent CSO's underlying cost of doing business. At the end of the quarter or some regular period, CSO 110 and lender 140 may review the transactions and, according to their business agreement, balance the books according the agreement to provide a restatement of the various loans whereby the loan payments and non-payments result in an adjustment of the letter of credit. In addition, CSO 110 may tally up the volume of loans made, and pay lender 140 a transaction fee (e.g., 1% of the volume) and 100% of the defaulted loans.

For consumer 130, the financial transaction is simple. The CSO 110 and consumer 130 agree that value asset represented by value asset information 123 is sufficient in value to pay for CSO transaction fee indicated in credit extension data 105. CSO 110 accepts the value asset represented by value asset 123 as collateral or security for payment of the CSO transaction fee and approves the loan application on behalf of the lender. Consumer 130 gets the loan 126 from lender 140. If consumer 130 pays back the loan and the CSO transaction fee, the value asset is returned to consumer 130. However, if consumer 130 does not pay, the CSO 110 may keep and convert the value asset as the CSO transaction fee.

With respect to the CSO 110, the financial transaction may be controlled and processed in whole or in part by CSO server 101, though it will be appreciated that one or more loan processing functions may be distributed or outsourced to one or more third party processing entities. For example, the loan, credit extension, and guaranty data may be stored at CSO entity 110. Under control of the CSO server 101, loan payments received from consumer 130 may be associated or matched with the corresponding promise-to-pay record, and a notice may be sent to lender 140 to indicate that a payment has been received. The matching of the consumer's payment to the promise-to-pay record may occur in any desired way, such as by receiving proof of identity and payment from consumer 130, receiving a transaction identifier associated with consumer 130, and the like. If all required loan payments of principal and interest are made by consumer 130, the credit extension data 105 may be modified to indicate that the value asset may be transformed to indicate that the consumer may recover the value asset, provided that the CSO transaction fee is paid. On the other hand, if the required loan payments are not made by consumer 130, the stored signal data representing the value asset may be transformed to indicate that consumer 130 may not recover the value asset, thereby signaling that CSO entity 110 may convert the value asset for purposes of paying the loan principal and interest to the lender and/or retaining the CSO transaction fee.

As will be appreciated, the transformation of the stored data signal representing the value asset may refer to the action and/or processes of a computer system (or similar electronic computing device) that manipulates and/or transforms data represented as physical (electronic) quantities within the computer system's registers and memories into other data similarly represented as physical quantities within the computer system memories or registers or other such information storage, transmission or display devices. For example, an electronic signal representing the value asset may be stored as a data record in the form of a database entry, table entry, data field or other predetermined parameter or location in an electronic file, database, record, or the like, to indicate that the value asset is to be returned to the consumer upon timely payment of the principal amount of money, interest payments, and CSO transaction fee. In addition, the electronic signal representing the value asset may be transformed t indicate that value asset is to be converted by CSO 110, such as by storing a different data record value in the form of a database entry, table entry, data field or other predetermined parameter or location in an electronic file, database, record, or the like. Alternatively, the transformation of the electronic signal may be implemented by storing a data record value as a different database entry, table entry, data field or other predetermined parameter or location in an electronic file, database, record, or the like.

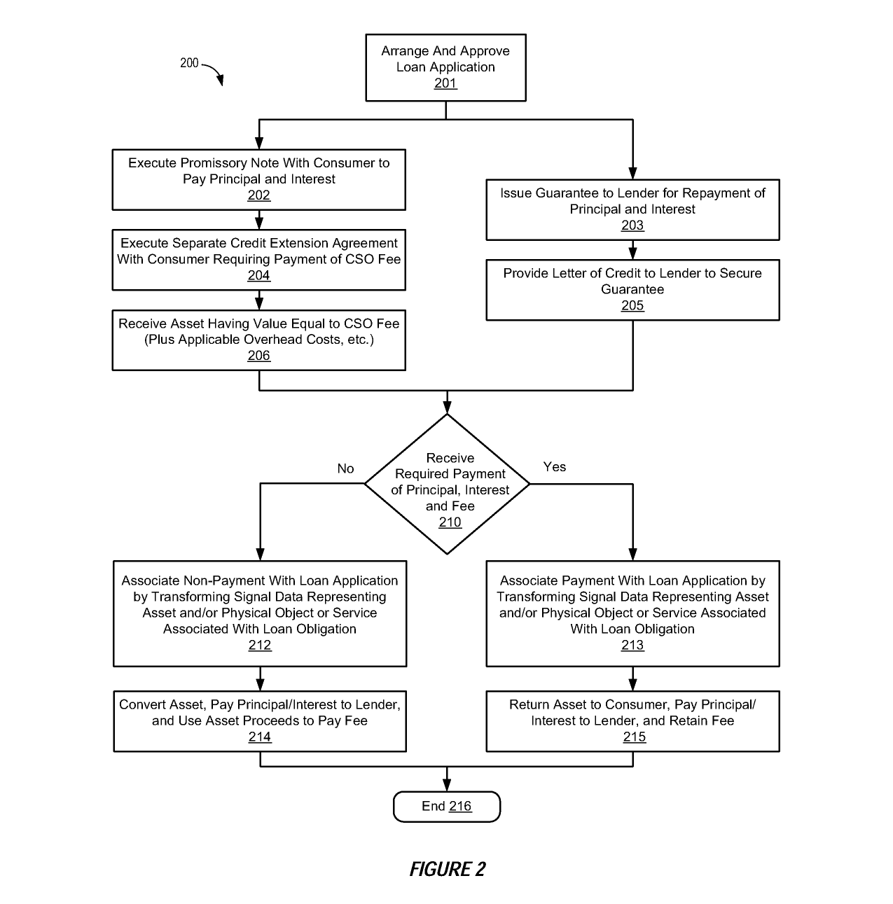

With reference to FIG. 2, selected elements of an embodiment of a method 200 for the operation of a universal credit services organization transaction as between a CSO, a lender, and a consumer are shown. The depicted embodiment of method 200 may be performed at least partially by CSO 110 and server 101, entity which act independently of lender 140 and consumer 130 (e.g., having no common ownership, directors, officers or employees).

At step 201, the CSO provides financing services relating to the arrangement and approval of a loan application by the consumer using underwriting criteria furnished by the lender. In this role, the CSO is not a general agent for the lender and does not lend money to the consumer, but acts as an LSA for the lender when processing the loans from the lender to the consumer and collecting monies due to the lender. In arranging the loan, the CSO ensures that the loan conforms to legal requirements for interest-rate limitations, and handles all paperwork incidental to the loan.

At step 202, the CSO processes an approved loan application by executing a promissory note with the consumer whereby the consumer promises to repay the loan amount, including principal and interest at a specified schedule. The promissory note may be implemented as a promise-to-pay record requiring direct or electronic payment to the CSO, where the promise-to-pay record includes, inter alia, a customer account number, a customer order number, the customer name, customer address, customer telephone, customer email address, the payment amount, and, if applicable, taxes or other related fees or discounts. At step 204, the CSO simultaneously enters into a separate contract with the consumer in which consumer agrees to pay the CSO a fee for obtaining an extension of consumer credit for the Consumer and otherwise arranging the loan. In support of the foregoing, the consumer provides at step 206 an asset representing the value of at least the CSO transaction fee, alone or in combination with any applicable overhead costs and/or the amount of principal and interest. In selected embodiments, the asset may be personal property or some other valuable physical object having a redeemable value equal to at least the sum of the outstanding principal, interest and CSO transaction fee. This asset may be held by CSO without transferring title from consumer unless and until a CSO transaction fee payment default occurs as described herein.

In connection with processing the loan application, the CSO may also capture, store, process, and transform data related to the lender and any payment obligations, payment values, and/or physical object or service associated therewith. The captured or stored data may include, but is not limited to, the lender's system information, name, address, contact information, and the like. In connection with the lender's loan to the consumer, the CSO may guaranty repayment of loan principal and interest to the lender at step 203. The guaranty amount may cover not just a single loan, but may instead apply to all CSO-brokered loans by the lender. In support of the foregoing, the CSO may also provide at step 205 a letter of credit to lender to secure the CSO's guaranty of payment. It is important to note that the issuance of a guaranty and any associated of credit to the lender by the CSO does not constitute any loan or money advance from the CSO to any consumer.

As will be appreciated, the foregoing steps 201-206 may be implemented in parallel, in sequence, or in some combination thereof. In addition, the loan processing steps by the CSO, agreement execution and payment value tender steps with the consumer, and issuance of guaranties and letters of credit to the lender will all occur prior to any consumer attempt to tender payment.

Once the loan application has been approved and the consumer begins repaying the loan amount, the CSO or a payment service provider associated therewith may pull or receives the associated account information for the consumer which may include the relevant promise-to-pay record. The CSO or payment service provider may validate all relevant data prior to proceeding to ensure that the record is complete prior to associating the payment to the particular loan transaction or promise-to-pay record. In some embodiments, the promise-to-pay record includes time limits for receipt of payment, the transaction identifier, any or all of the above noted customer information, notes or comments identifying key legal or operational elements, that may further include a requirement that the customer provide identification prior to submission of payment.

At step 210, the CSO determines if the required payments of principal, interest, and CSO transaction fee have been made by the consumer. If all required payments are made (affirmative outcome to decision block 210), the loan repayment terms have been met. In the CSO records, this loan payment may be associated with the loan application or promise-to-pay record at step 213 by transforming a signal data representing the asset to indicate that the asset may be returned to the consumer. At step 215, the CSO returns the asset to the consumer, pays the principal and interest amounts to the lender, and retains the CSO transaction fee as compensation. However, in the event a consumer fails to timely pay the CSO transaction fee (negative outcome to decision block 210), the CSO may perform a transaction in which the asset is used to satisfy at least the CSO transaction fee, if not also any unpaid portion of the debt owed by the consumer. This transaction may be staged at step 212 by transforming a signal data representing the asset to indicate that the asset may be converted by the CSO. At step 214, the CSO converts the asset, pays the principal and interest amounts to the lender, and uses the proceeds from converting the asset as payment of the CSO transaction fee. At the conclusion of the universal credit services organization transaction, the methodology ends at step 216.

As described herein, the CSO may use any desired asset to secure payment of the CSO transaction fee, if not also the principal, interest, and any applicable overhead costs of doing business. One example would be for the consumer to deliver personal property to the CSO as security for CSO's fee when the consumer signs the promissory note to the lender. In this arrangement, the credit extension agreement (step 204) will specify that the consumer retains title to the personal property and may, at his option, reclaim the personal property by paying the CSO transaction fee in the event that the consumer pays the principal and interest of the loan by the required due date. However, in the event of non-payment of the loan principal and interest and CSO transaction fee by the due date, the CSO transaction agreement (step 204) may specify that the CSO may convert the personal property and take title thereto. With this arrangement, the CSO may convert the personal property at step 214 by taking title to the personal property and disposing of the property in any lawful manner as it sees fit, with no further obligation to account to the consumer for the property or the proceeds of any sale of the property. With this embodiment of the universal credit services organization transaction, the lender takes no security interest in or right of recourse to the personal property pledged as security for CSO transaction fee. However, it will also be appreciated that the consumer's debt for repaying the loan amount is not canceled or otherwise satisfied by payment of CSO transaction fee, whether in cash or personal property.

By now, it will be appreciated that method 200 may be embodied in a computer program product which uses a computer usable medium with computer readable program code embodied therein which is adapted to be executed by a processor to implement one or more steps to implement a method for facilitating a financial transaction through a CSO. In the disclosed computer-implemented methodology, a system is provided with distinct software modules, including at least a logic processing module and a storage module. In the logic processing module, a financial transaction is processed at the CSO between a consumer and a lender whereby the consumer borrows a principal amount of money from the lender at a predetermined interest rate. In the storage module, information relating to a promise-to-pay record from the consumer is stored that specifies an obligation from the consumer to pay to the CSO the principal amount of money along with interest payments corresponding to the predetermined interest rate. In addition, the storage module stores information relating to an agreement from the consumer specifying an obligation from the consumer to pay a CSO transaction fee to the CSO for facilitating the financial transaction, and also stores an electronic signal representing separate property, also referred to herein as a value asset, received by the CSO from the consumer having a value equaling at least the CSO transaction fee. In selected embodiments, the separate property has a value equaling at least the principal amount of money, interest payments, and CSO transaction fee, while in other embodiments, the separate property has a value equaling at least the CSO transaction fee and an overhead business cost associated with the consumer. At the processing module, the electronic signal representing the separate property is transformed upon failure of the consumer to pay the principal amount of money, interest payments, and CSO transaction fee to indicate that the separate property is to be converted by the CSO. The processing module may also transform the electronic signal representing the separate property upon payment by the consumer of the principal amount of money, interest payments, and CSO transaction fee to indicate that the separate property is to be returned to the consumer.

In other embodiments, there is disclosed a method and system for staging a financial transaction between a customer and a lender. As disclosed, a CSO, acting as a limited special agent for the lender, receives an application from the customer for a loan from the lender, and also receives a first agreement between the CSO and the customer wherein the customer agrees to pay a specified principal and interest amounts to the CSO as LSA for the lender. The CSO also receives a second agreement between the CSO and the customer wherein the customer agrees to pay a transaction fee to the CSO in exchange for facilitating the loan from the lender to the customer. As security for the CSO transaction fee, the CSO also receives separate property (e.g., personal property owned by the customer) having a value equaling at least the Transaction Fee, if not also the principal and interest amounts and/or overhead business cost associated with the customer. Acting as an LSA for the lender, the CSO approves the application from the customer for the loan from the lender if predetermined loan criteria are satisfied by the customer, and sends a notice of loan approval of the application from the customer for the loan from the lender. In support of the financial transaction, the CSO may issue a guaranty to the lender for payment of any outstanding principal and interest owed to the lender on any loan approved by the CSO, and may also issue a letter of credit to the lender to secure payment of the guaranty. Upon timely payment by the customer of the specified principal and interest amounts and the CSO transaction fee pursuant to the first and second agreements, the CSO returns the separate property to the customer. Acting as an LSA for the lender, the CSO receives payments by the customer of specified principal and interest amounts pursuant to the first agreement, and forwards to the lender any payment by the customer of specified principal and interest amounts. But if timely payments are not received, the CSO retains the separate property for payment of at least the CSO transaction fee if there is not timely payment by the customer of the specified principal and interest amounts and the CSO transaction fee pursuant to the first and second agreements.

The computer-based data processing system described above is for purposes of example only, and may be implemented in any type of computer system or programming or processing environment, or in a computer program, alone or in conjunction with hardware. Various embodiments of the present may also be implemented in software stored on a computer-readable medium and executed as a computer program on a general purpose or special purpose computer. It should be understood that the disclosed subject matter is not limited to any specific computer language, program, or computer. It is further contemplated that disclosed methods and constructions may be run on a stand-alone computer system, or may be run from a server computer system that can be accessed by a plurality of client computer systems interconnected over an intranet network, or that is accessible to clients over the Internet.

Although the described exemplary embodiments disclosed herein are directed to various embodiments, disclosed subject matter is not necessarily limited to the example embodiments. Thus, the particular embodiments disclosed above are illustrative only and should not be taken as limitations, as the disclosed embodiments may be modified and practiced in different but equivalent manners apparent to those skilled in the art having the benefit of the teachings herein. In addition, while selected benefits, advantages, and solutions to problems have been described above with regard to specific embodiments, the benefits, advantages, solutions to problems, and any element(s) that may cause any benefit, advantage, or solution to occur or become more pronounced are not to be construed as a critical, required, or essential feature or element of any or all the claims. Accordingly, the foregoing description is not intended to limit disclosed embodiments to the particular form set forth, but on the contrary, is intended to cover such alternatives, modifications, and equivalents of the claimed subject matter.

What is claimed is:

1. A method for facilitating a financial transaction through a CSO comprising:
processing a financial transaction at the CSO as a limited special agent for a lender, whereby a consumer borrows a principal amount of money from the lender at a predetermined interest rate;
receiving a promise-to-pay record from the consumer specifying an obligation from the consumer to pay to the CSO as an LSA for a lender the principal amount of money along with interest payments corresponding to the predetermined interest rate;
receiving an agreement from the consumer specifying an obligation from the consumer to pay a transaction fee to the CSO for facilitating the financial transaction;
receiving separate property from the consumer having a value equaling at least the CSO transaction fee;
storing at the CSO an electronic signal representing the separate property, where the electronic signal indicates that the separate property is to be returned to the consumer upon timely payment of the principal amount of money, interest payments, and CSO transaction fee to the CSO; and
transforming the electronic signal representing the separate property upon failure of the consumer to pay the principal amount of money, interest payments, and CSO transaction fee, where the transformed electronic signal indicates that the separate property is to be converted by the CSO.

2. The method of claim 1, where processing the financial transaction comprises approving a loan application using underwriting criteria furnished by the lender.

3. The method of claim 1, where receiving the promise-to-pay record comprises executing a promissory note between the CSO, on behalf of the lender, and consumer.

4. The method of claim 1, where receiving separate property comprises receiving personal property owned by the consumer having a value equal to at least the principal amount of money, interest payments, and CSO transaction fee.

5. The method of claim 1, where receiving separate property comprises receiving personal property from the consumer as security for the CSO transaction fee.

6. The method of claim 1, further comprising issuing a guaranty from the CSO to the lender for payment of any outstanding principal and interest owed to the lender.

7. The method of claim 6, further comprising issuing a letter of credit from the CSO to the lender to secure the guaranty.

8. The method of claim 1, further comprising displaying an image of the separate property on a computer screen.

9. The method of claim 1, further comprising:
receiving a loan payment from the consumer at the CSO as a limited special agent for the lender; and
associating the payment with the promise-to-pay record.

10. A computer readable medium including processor-executable program code to cause a processor to perform financial transaction operations, comprising:
receiving, by a CSO server, transaction information indicative of a financial transaction between a consumer and a lender wherein the financial transaction information indicates an identity of a consumer, a principal amount of money burrowed by the consumer, an interest rate for associated with the financial transaction, and an identify of a lender loaning the principal amount to the consumer at the predetermined interest rate;
receiving promise-to-pay information indicative of a first promise by the consumer to make principal and interest payments to the CSO, as a limited special agent for the lender, based on the predetermined interest rate;
receiving transaction fee information indicative of a consumer promise and a consumer obligation to pay a transaction fee to the CSO in conjunction with the financial transaction;
receiving and storing value asset data including data indicative of:
a value asset provided to the CSO by the consumer;
a value of the asset; and
a legal owner of the asset; and
responsive to receiving default information indicative of either:
a failure by the consumer to make a principal and interest payment according to the promise-to-pay information; or
a failure by the consumer to pay the transaction fee according to the transaction fee information,
transforming the property data to indicate the CSO as the legal owner of the asset.

11. The computer readable medium of claim 10, further comprising modifying the value asset data upon payment by the consumer of the principal amount of money, interest payments, and CSO transaction fee to indicate that the value asset is to be returned to the consumer, where transforming the electronic signal is performed by the processing module.

12. The computer program product of claim 10, wherein the value asset data identifies the value asset received by the CSO from the consumer having a value equaling at least the principal amount of money, interest payments, and CSO transaction fee.

13. The computer program product of claim 10, wherein the value asset has a value equaling at least the CSO transaction fee and an overhead business cost associated with the consumer.

14. A method for staging a financial transaction between a customer and a lender, comprising:
receiving, at a CSO acting as a limited special agent for the lender, an application from the customer for a loan from the lender;
receiving, at the CSO acting as a limited special agent for the lender, a first agreement between the CSO and the customer wherein the customer agrees to pay a specified principal and interest amounts to the CSO;
receiving, at the CSO, a second agreement between the CSO and the customer wherein the customer agrees to pay a CSO transaction fee to the CSO in exchange for facilitating the loan from the lender to the customer;
receiving, at the CSO, a value asset having a value equaling at least the CSO transaction fee;
approving, at the CSO acting as a limited special agent for the lender, the application from the customer for the loan from the lender if predetermined loan criteria are satisfied by the customer;
sending a notice of loan approval of the application from the customer for the loan from the lender; and
returning the separate property to the customer upon timely payment by the customer of the specified principal and interest amounts and the CSO transaction fee pursuant to the first and second agreements, but otherwise retaining at the CSO the value asset for payment of at least the CSO transaction fee if there is not timely payment by the customer of the specified principal and interest amounts and the CSO transaction fee pursuant to the first and second agreements.

15. The method of claim 14, where the value asset has a value equaling at least the principal and interest amounts and the CSO transaction fee.

16. The method of claim 14, where the value asset has a value equaling at least the CSO transaction fee and an overhead business cost associated with the customer.

17. The method of claim 14, further comprising issuing from the credit services organization a guaranty to the lender for payment of any outstanding principal and interest owed to the lender on any loan approved by the CSO.

18. The method of claim 17, further comprising issuing from the CSO a letter of credit to the lender to secure payment of the guaranty.

19. The method of claim 14, where receiving the value asset comprises receiving personal property owned by the customer.

20. The method of claim 14, further comprising:
receiving, at the CSO acting as a limited special agent for the lender, payment by the customer of specified principal and interest amounts pursuant to the first agreement; and
forwarding to the lender any payment by the customer of specified principal and interest amounts.
